(19) United States
(12) Patent Application Publication
(10) Pub. No.: US 2017/0004726 A1
(43) Pub. Date: Jan. 5, 2017

(54) SCENARIO RESPONSE SIMULATION

(71) Applicant: The Boeing Company, Chicago, IL (US)

(72) Inventors: Liisa C. Bruchal, Seattle, WA (US); William A. Harkness, Mukilteo, WA (US); Richard A. McLean, Monroe, WA (US)

(73) Assignee: The Boeing Company

(21) Appl. No.: 14/788,466

(22) Filed: Jun. 30, 2015

(51) Int. Cl. G09B 9/00; G09B 19/00; G06Q 30/02

(52) U.S. Cl. CPC G09B 9/00; G06Q 30/0207; G09B 19/00

(57) ABSTRACT

In an example, a method includes selecting, at a server, a set of participants to simulate a first response scenario. The set of participants includes at least a first participant. The method includes sending first instructions from the server to a first computing device associated with the first participant. The first instructions identify the first response scenario. The method includes determining, at the server, whether the first participant satisfied first response criteria associated with a first response operation. The method further includes determining a first reward to be provided to the first participant in response to determining that the first participant satisfied the first response criteria.

### FIELD OF THE DISCLOSURE

The present disclosure is generally related to scenario response simulation.

### BACKGROUND

Organizations may devote a significant amount of money and resources to safety training. One aspect of safety training that is particularly expensive and time consuming is safety drills. Safety drills, such as fire drills, etc., can divert significant time and energy away from the business of the organization. However, response simulation plays an important role in emergency preparedness.

### SUMMARY

In a particular embodiment, a method includes selecting, at a server, a set of participants to simulate a first response scenario. The set of participants includes at least a first participant. The method includes sending first instructions from the server to a first computing device associated with the first participant. The first instructions identify the first response scenario. The method includes determining, at the server, whether the first participant satisfied first response criteria associated with a first response operation. The method further includes determining a first reward to be provided to the first participant in response to determining that the first participant satisfied the first response criteria.

In another particular embodiment, a system includes a processor and a memory accessible to the processor. The memory includes instructions that are executable by the processor to perform various operations. The operations include determining a set of participants to simulate a response scenario, where the set of participants includes at least a first participant. The operations include sending, to a first computing device associated with the first participant, first information that identifies the first response scenario. The operations further include determining a first reward to be provided to the first participant in response to the first participant satisfying first response criteria associated with a first response operation.

In another particular embodiment, a computer-readable storage medium is disclosed. The computer-readable storage medium includes instructions that are executable by a processor to perform various operations. The operations include determining a set of participants to simulate a response scenario. The set of participants includes at least a first participant and a second participant. The operations include sending first instructions to a first computing device associated with the first participant. The first instructions identify the response scenario. The operations include sending second instructions to a second computing device associated with the second participant. The second instructions identify the response scenario. The operations include providing a first reward to the first participant in response to determining that first response criteria associated with a first response operation is satisfied. The operations further include providing a second reward to the second participant in response to determining that second response criteria associated with a second response operation is satisfied.

The features, functions, and advantages that have been described can be achieved independently in various embodiments or may be combined in other embodiments, further details of which are disclosed with reference to the following description and drawings.

### BRIEF DESCRIPTION OF THE DRAWINGS

FIG. 1 is a diagram illustrating a system of simulating a response scenario, according to one embodiment;

FIG. 2 is a diagram illustrating a system of rewarding a participant in the simulated response scenario for satisfying response criteria, according to one embodiment;

FIG. 3 is a diagram illustrating a system of simulating a response scenario, according to one embodiment;

FIG. 4 is a diagram illustrating a system of rewarding a participant in the simulated response scenario for satisfying first response criteria associated with a first response operation, according to one embodiment;

FIG. 5 is a diagram illustrating a system of rewarding a participant in the simulated response scenario for satisfying second response criteria associated with a second response operation, according to one embodiment;

FIG. 6 is a flow chart illustrating a particular embodiment of a method of determining whether to reward a participant in a simulated response scenario based on whether the participant satisfied particular response criteria; and

FIG. 7 is an illustration of a block diagram of a computing environment including a general purpose computing device configured to support embodiments of computer-implemented methods and computer-executable program instructions (or code) according to the present disclosure.

### DETAILED DESCRIPTION

The present disclosure describes systems and methods of rewarding a participant in a simulated response scenario when the participant satisfies particular response criteria (associated with a particular response operation to be performed by the participant). In some cases, the simulated response scenario may include a simulation of a particular response scenario (e.g., an emergency/hazard response scenario). A simulation of the particular response scenario may result in the participant being more engaged and more likely to be prepared in the event of an actual response scenario. Rewarding the participant for being capable of performing a particular response operation (or multiple response operations) may further encourage the participant to be engaged in the simulation. When the participant is not capable of performing the particular response operation (or multiple response operations), the lack of a reward may incentivize the participant to improve his/her scenario response skillset (e.g., to obtain CPR certification, to learn the locations of various safety equipment devices/exits, etc.).

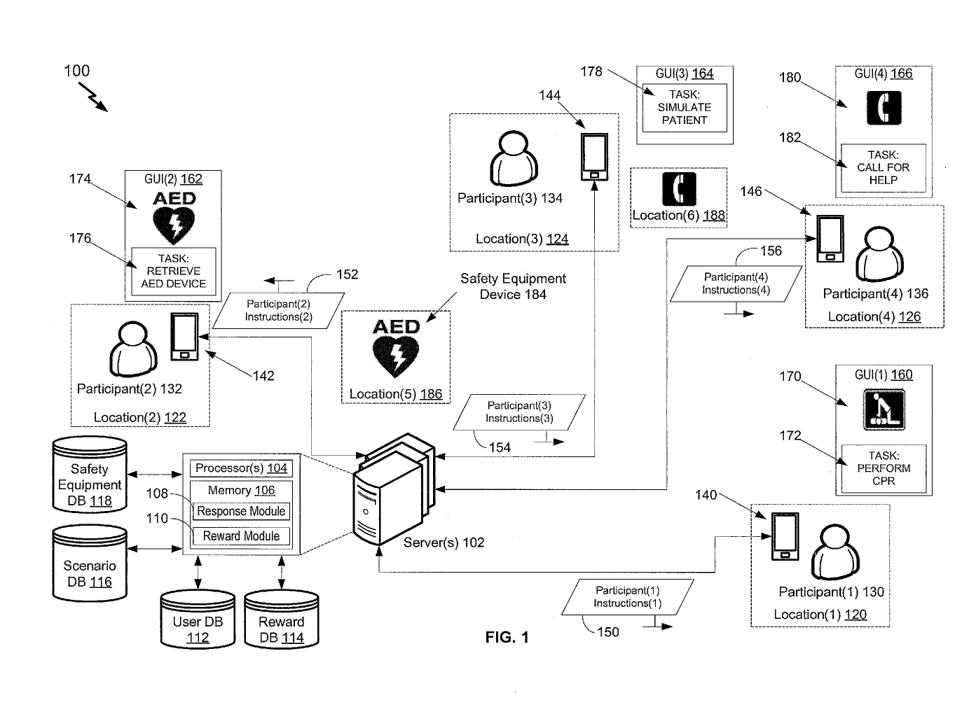

Referring to FIG. 1, a particular embodiment of a system of simulating a response scenario is illustrated and generally designated 100. In the example of FIG. 1, the response scenario includes a simulated response to a medical emergency (e.g., a suspected heart attack). In other cases, the response scenario may include another emergency response scenario, a non-emergency response scenario, or a safety hazard response scenario, among other alternatives. Further, an application programming interface (API) may allow an organization/department to “plug in” applications/widgets/scenarios that are appropriate for the particular organization. As an illustrative, non-limiting example, a particular response scenario may be applicable for one department with potentially hazardous chemicals (e.g., a paint shop) but may be inapplicable for another department without such chemicals (e.g., an aircraft assembly area). Thus, an API may allow for customization of particular response scenarios based on applicability to an organization, a department, or an environment (among other alternatives).

The system 100 includes a server 102 (or multiple servers) and computing device(s) associated with participant(s) selected by the server 102 to simulate a particular response scenario. The server 102 includes a processor 104 (or multiple processors) and a memory 106 accessible to the processor 104. The memory 106 stores instructions that are executable by the processor 104 to perform various operations. In the example of FIG. 1, the memory 106 includes a response module 108 and a reward module 110. FIG. 1 further illustrates that a user database 112, a reward database 114, a scenario database 116, and a safety equipment database 118 may be accessible to the server 102. The scenario database 116 may include information associated with particular response operations to be performed for various response scenarios. In some cases, the response module 108 may be configured to identify a particular safety equipment device associated with a particular emergency response operation (based on information stored at the scenario database 116). The safety equipment database 118 may include location data associated with multiple safety equipment devices (e.g., AED devices, fire extinguishers, first aid kits, telephones, chemical/biological response equipment, etc.).

The response module 108 may be configured to identify a set of participants to simulate a particular response scenario (e.g., a first response scenario). As an illustrative, non-limiting example, the set of participants may be selected based on a group affiliation, a workplace responsibility, or a combination thereof (among other alternatives). In the particular embodiment illustrated in FIG. 1, the set of participants includes a first participant 130, a second participant 132, a third participant 134, and a fourth participant 136. While FIG. 1 illustrates an example of four participants being selected, it will be appreciated that an alternative number of participants may be selected (e.g., based on a number and/or type of response operations to be performed).

FIG. 1 illustrates that a first computing device 140 is associated with the first participant 130, a second computing device 142 is associated with the second participant 132, a third computing device 144 is associated with the third participant 134, and a fourth computing device 146 is associated with the fourth participant 136. While the computing devices 140-146 are illustrated in the example of FIG. 1 as phones, it will be appreciated that alternative devices may be utilized. Further, while components of the computing devices 140-146 (e.g., a processor, memory, etc.) are not shown in the example of FIG. 1, it will be appreciated that the computing devices 140-146 may include hardware, software, or a combination thereof for performing various operations associated with response scenario simulation. For example, the computing devices 140-146 may include a processor and a memory storing data and/or instructions, such as a workplace safety application.

The server 102 is configured to send instructions to computing device(s) associated with the selected participant(s). The instructions may identify a response scenario and/or a response operation (or multiple response operations) to be performed by a particular participant (or multiple participants). As illustrative, non-limiting examples, the instructions may include data for use by a workplace safety application at a computing device, a short message service (SMS) message, or an email message. In the particular embodiment illustrated in FIG. 1 (in which four participants are selected), the server 102 may be configured to send first instructions 150 to the first computing device 140 (associated with the first participant 130), to send second instructions 152 to the second computing device 142 (associated with the second participant 132), to send third instructions 154 to the third computing device 146 (associated with the third participant 136), and to send fourth instructions 156 to the fourth computing device 146 (associated with the fourth participant 136). While not shown in the example of FIG. 1, the server 102 may be configured to send instructions to individual computing device(s) via a network (or multiple networks).

FIG. 1 illustrates an example in which the first response scenario includes an emergency response scenario (e.g., a medical emergency, such as an individual experiencing heart attack symptoms). In the particular embodiment illustrated in FIG. 1, the response module 108 determines a set of emergency response operations to be performed, with one or more emergency response operations assigned to each selected participant (e.g., the four participants 130-136 in the example of FIG. 1). As an illustrative, non-limiting example, the set of emergency response operations may include a first operation/task (to be performed by the first participant 130), a second operation/task (to be performed by the second participant 132), a third operation/task (to be performed by the third participant 134), and a fourth operation/task (to be performed by the fourth participant 136). Information associated with the individual operations/tasks may be included in the instructions that are communicated from the server 102 to the individual computing devices 140-146 of the participants 130-136. Alternatively, the server 102 may select the response scenario, provide information to the participants 130-136 that identifies the response scenario, and evaluate the participants 130-136 based on whether the participants 130-136 identified/performed the proper response operations associated with the response scenario.

FIG. 1 illustrates that the individual computing devices 140-146 may be configured to display a user interface (e.g., a graphical user interface (GUI)) that provides information associated with a response scenario. For example, the user interface may display information associated with an assigned task/operation to be performed by the individual participants 130-136. Illustrative examples of emergency response operations include calling emergency telephone number(s), performing cardiopulmonary resuscitation (CPR), retrieving/utilizing an AED device, performing mitigation activities, providing logistical support, or providing response coordination, among other alternatives.

The reward module 110 is configured to determine a reward to be provided to a participant when the response module 108 determines that the participant satisfied particular response criteria associated with a particular response scenario. To illustrate, the reward module 110 may be configured to access the reward database 114 to determine the reward. In some cases, the reward may be determined based at least in part on a response scenario type (e.g., an emergency response scenario, a non-emergency response scenario, a hazard response scenario, etc.) associated with the particular response operation(s) to be performed. In some cases, the reward may further be determined based on a number of response operations performed by a particular participant that satisfy response criteria and/or a time to perform the particular response operation(s), among other alternatives. In some cases, the number of response operations performed by individual participants may be stored at the user database 112 and/or the reward database 114.

In operation, the response module 110 may access the scenario database 116 to determine a set of response operations to be performed for a particular response scenario. In the example of FIG. 1, the response scenario corresponds to an emergency response scenario for an individual experiencing symptoms associated with a heart attack (among other possible symptoms/conditions/injuries). The scenario database 116 may indicate that multiple response operations are appropriate in such an emergency scenario. In the particular embodiment illustrated in FIG. 1, four response operations are shown for illustrative purposes only. It will be appreciated that alternative/additional response operations may be appropriate for a suspected heart attack (among other possible conditions/injuries). Based on information stored at the scenario database 116, the response module 108 may determine that one response operation may include performing cardiopulmonary resuscitation (CPR). The response module 108 may determine that another response operation may include retrieving/delivering a safety equipment device 184 (e.g., an automated external defibrillator (AED) device). The response module 108 may determine that another response operation may include calling one or more emergency numbers (e.g., 911, an internal emergency number, etc.). Further, the response module 108 may determine that, in order to simulate a response to a possible heart attack, an individual is to be tasked with simulating a patient. In some cases, participants may be “graded” on identifying proper responses and/or performing response operations. For example, the response module 108 may prompt the participants 130-136 to identify response operations to be performed for a particular response scenario. Alternatively, as illustrated in the example of FIG. 1, the response module 108 may assign response operation(s) to the participants 130-136.

In the example illustrated in FIG. 1, the response module 108 selects the first participant 130 to perform a first response operation (e.g., performing CPR). The response module 108 selects the second participant 132 to perform a second response operation (e.g., retrieving/delivering an AED device). The response module 108 selects the third participant 134 to perform the task of simulating a patient. The response module 108 selects the fourth participant 136 to perform a third response operation (e.g., dialing one or more emergency telephone numbers).

The response module 108 may send the first instructions 150 to the first participant 130, the second instructions 152 to the second participant 132, the third instructions 154 to the third participant 134, and the fourth instructions 156 to the fourth participant 136. In the particular embodiment illustrated in FIG. 1, the first computing device 140 associated with the first participant 130 is configured to display a first user interface 160 (identified as “GUI(1)” in FIG. 1) responsive to receiving the first instructions 150 (e.g., instructions associated with a first emergency response scenario and/or a first emergency response operation). The second computing device 142 associated with the second participant 132 is configured to display a second user interface 162 (identified as “GUI(2)” in FIG. 1) responsive to receiving the second instructions 152 (e.g., instructions associated with a second emergency response scenario and/or a second emergency response operation). The third computing device 144 associated with the third participant 134 is configured to display a third user interface 164 (identified as “GUI(3)” in FIG. 1) responsive to receiving the third instructions 154 (e.g., instructions associated with a third emergency response scenario and/or a third emergency response operation). The fourth computing device 146 associated with the fourth participant 136 is configured to display a fourth user interface 166 (identified as “GUI(4)” in FIG. 1) responsive to receiving the fourth instructions 156 (e.g., instructions associated with a fourth emergency response scenario and/or a fourth emergency response operation).

In the illustrative, non-limiting example of FIG. 1, the first user interface 160 displayed at the first computing device 140 includes a first indication 170 (e.g., a graphical illustration of an individual performing CPR) and a second indication 172 (e.g., textual information indicating that the first participant 130 is tasked with performing CPR). The second user interface 162 displayed at the second computing device 142 includes a first indication 174 (e.g., a graphical illustration of an AED device) and a second indication 176 (e.g., textual information indicating that the second participant 132 is tasked with retrieving/delivering an AED device). The third user interface 164 displayed at the third computing device 144 includes an indication 178 (e.g., textual information) that the third participant 134 is tasked with simulating a patient that is experiencing heart attack symptoms. The fourth user interface 166 displayed at the fourth computing device 146 includes a first indication 180 (e.g., a graphical illustration of a telephone) and a second indication 182 (e.g., textual information indicating that the fourth participant 136 is tasked with calling for help).

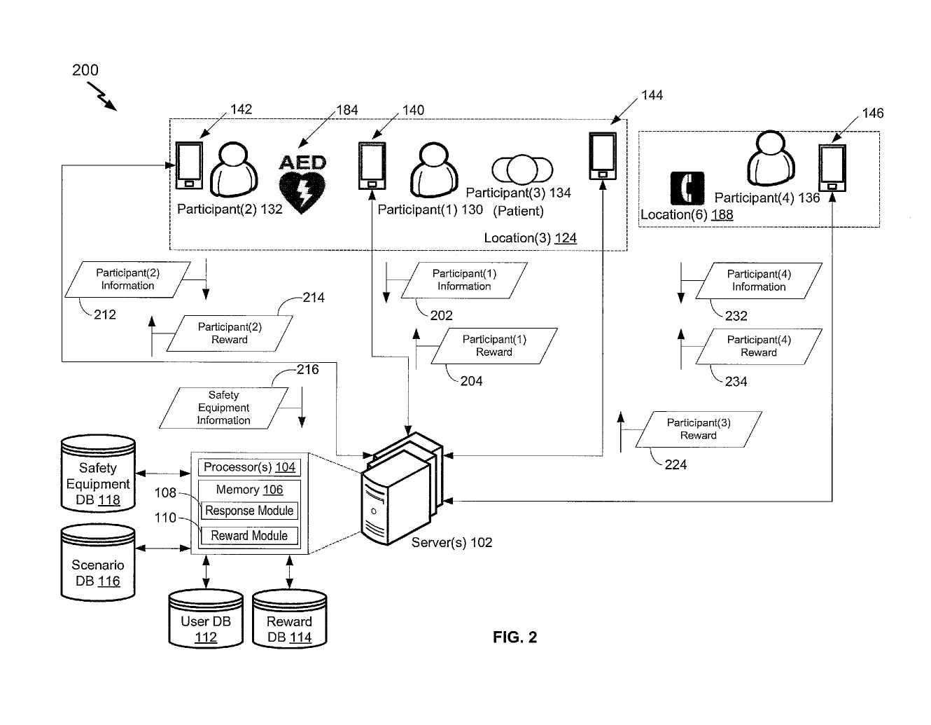

As described further herein with respect to FIG. 2, the response module 108 may determine, based on information received from the individual computing devices 140-146, whether the response operation(s) identified by or performed by the individual participants 130-136 satisfy particular response criteria. When a particular response operation satisfies response criteria associated with the particular response scenario, the reward module 110 may determine that a participant is to receive a reward. As further described herein, the reward may be determined based on a nature/type of the particular response operation, a number of response operations previously completed by the participant, an amount of time for the participant to perform the particular response operation, or a combination thereof (among other alternatives). When the particular response operation does not satisfy the response criteria associated with the particular response scenario, the reward module 110 may determine that the participant is to receive no reward (or a reduced reward, a reward balance deduction, etc.). Alternatively, the server 102 may schedule or suggest training for the participant.

In the particular embodiment illustrated in FIG. 1, the first participant 130 is located at a first location 120, and the third participant 134 (tasked with simulating the patient) is located at a third location 124. As an illustrative, non-limiting example, the response criteria associated with performing the first response operation (e.g., performing CPR) may correspond to the first participant 130 arriving at the third location 124 within a threshold time period. While not illustrated in the example of FIG. 1, in some cases, the server 102 may receive information from sensor(s) at the third location 124 to determine whether the first participant 130 correctly simulated CPR. Alternatively, the server 102 may receive information provided by one or more of the participants 130-136 via one or more of the computing devices 140-146, indicating whether CPR was successfully simulated. For example, the third computing device 144 may display a code, and a responder may enter the code in order to demonstrate that the responder is at the third location 124.

In the example of FIG. 1, the second participant 132 is located at a second location 122, and a safety equipment device 184 (e.g., an AED device) is located at a fifth location 186. As an example, the response criteria associated with performing the second response operation (e.g., retrieving/delivering the safety equipment device 184) may correspond to the second participant 132 successfully locating the safety equipment device 184 at the fifth location 186. The response criteria may further include the second participant 132 successfully delivering the safety equipment device 184 to the third location 124 (associated with the patient simulating the heart attack). While not illustrated in the example of FIG. 1, in some cases, the server 102 may receive information from sensor(s) at the fifth location 186 and/or the third location 124 to determine whether the second participant 132 correctly retrieved/delivered the safety equipment device 184. Alternatively, the server 102 may receive information provided by one or more of the participants 130-136 via one or more of the computing devices 140-146, indicating whether the safety equipment device 184 was successfully retrieved/delivered. For example, a responder may photograph the safety equipment device 184 or an associated location tag (e.g., a barcode, such as a matrix barcode). The server 102 may receive data confirming operations, compare the data to response criteria (e.g., whether the second participant 132 retrieved the closest AED device, a time for the second participant 132 to respond, etc.). The reward module 110 may assign rewards based on response operations and response criteria. Further, the server 102 may log data and generate reports to improve training (e.g., in locating safety equipment devices).

In the example of FIG. 1, the fourth participant 136 is located at a fourth location 126, and a communication device (e.g., a telephone) is located at a sixth location 188. As an example, the response criteria associated with performing the third response operation (e.g., calling one or more emergency telephone numbers) may correspond to the fourth participant 136 successfully locating the telephone at the sixth location 188 (and optionally utilizing the telephone). For example, a responder may photograph the telephone or an associated location tag (e.g., a barcode, such as a matrix barcode). The server 102 may receive data confirming operations, compare the data to response criteria (e.g., whether the fourth participant 136 located the closest telephone, a time for the fourth participant 136 to respond, etc.). The reward module 110 may assign rewards based on response operations and response criteria. Further, the server 102 may log data and generate reports to improve training (e.g., in locating emergency telephones).

Thus, FIG. 1 illustrates an example of a system of simulating a response scenario (e.g., an emergency/hazard response scenario). The simulation of the response scenario may result in a participant being more engaged and more likely to be prepared in the event of an actual response scenario. As described further herein with respect to FIG. 2, rewarding the participant for being capable of performing a particular response operation (or multiple response operations) may further encourage the participant to be engaged in the simulation.

FIG. 2 illustrates a particular embodiment of a system 200 for rewarding participant(s) in a simulated response scenario for being capable of performing a particular response operation (or multiple response operations). In FIG. 2, each of the participants 130-136 has responded to the instructions 150-156 from the server 102 and has successfully performed particular response operation(s) based on the instructions 150-156. FIG. 2 illustrates rewards being provided to each of the participants 130-136 for successfully performing the assigned response operations. As further described herein, in other cases, one or more of the participants 130-136 may fail to satisfy particular response criteria. In this case, a reward may not be provided to a particular participant, or rewards may not be provided to each participant of the group of participants 130-136. Thus, in some cases, individual participants may be rewarded independently for performing response operation(s) that satisfy response criteria. In other cases, a determination of whether to provide reward(s) may depend on every participant of the group successfully performing response operations associated with a particular response scenario.

In the particular embodiment illustrated in FIG. 2, the response module 108 may be configured to receive first information 202 (identified as “Participant(1) Information” in FIG. 2) from the first computing device 140 associated with the first participant 130. The response module 108 may be configured to determine, based on the first information 202, whether first response criteria associated with performing the first response operation (e.g., simulating CPR on the third participant 134 that is designated as the patient) is satisfied. When the first response criteria is satisfied, the reward module 110 may be configured to determine a first reward 204 to be provided to the first participant 132. FIG. 2 illustrates that, in some cases, information associated with the first reward 204 may be sent to the first computing device 140 (e.g., for display to the first participant 130).

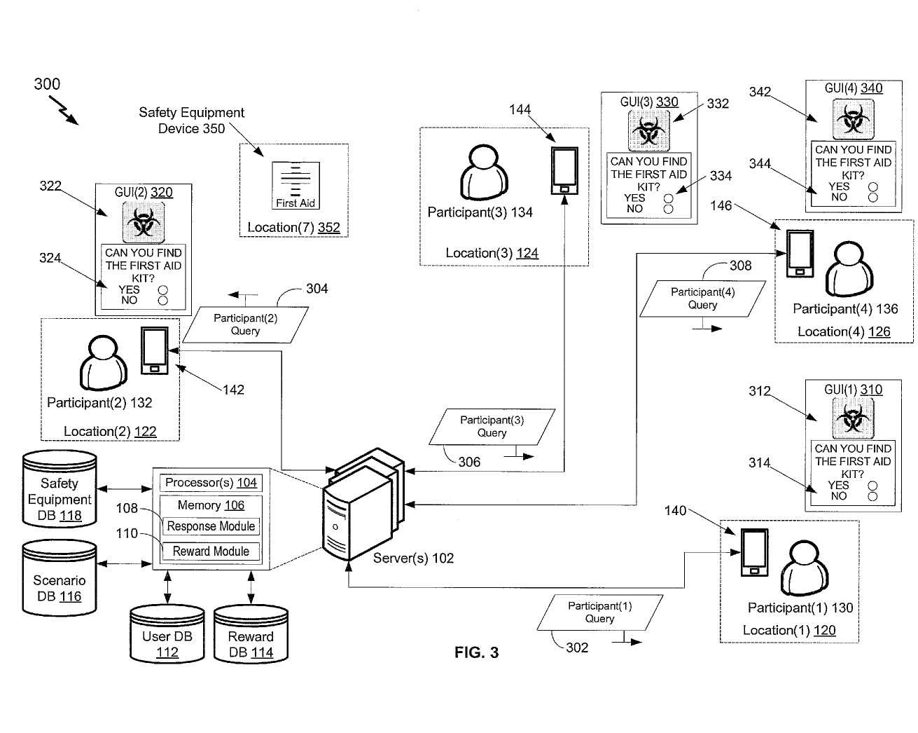

In some cases, the first information 202 may include first location information associated with the first computing device 140. In other cases, as illustrated and further described herein with respect to FIGS. 3-5, the response module 108 may receive an indication that the first participant 130 is capable of (or incapable of) performing the first response operation. In this case, the response module 108 may determine, based on the indication received from the first participant 130, whether the first response criteria is satisfied.

When the first information 202 includes first location information, the response module 108 may be configured to determine, based on the first location information, whether the first response criteria is satisfied. In a particular embodiment, the first location information may include a first set of global positioning system (GPS) coordinates associated with the first computing device 140. Alternatively, the first location information may include information associated with another positioning system (e.g., a local positioning system that identifies a location within a workplace, such as a particular building, a location within the particular building, etc.). The response module 108 may be configured to compare the first location information to location information associated with a location where a response scenario is to be simulated (e.g., the third location 124 in the example emergency medical response scenario of FIGS. 1 and 2).

In the particular embodiment illustrated in FIGS. 1 and 2, the response scenario corresponds to an emergency response scenario (e.g., a medical emergency). In this case, the reward module 110 may determine the first reward 204 based at least in part on an emergency response type associated with the first emergency response operation (e.g., by querying the reward database 114 based on the emergency response type). In alternative embodiments, the response scenario may correspond to a safety hazard response scenario. As illustrative, non-limiting examples, the safety hazard response scenario may correspond to a fire hazard, a chemical spill hazard, a lighting hazard, a tripping hazard, a broken glass hazard, a broken tool hazard, a cross-walk hazard, an iced surface hazard, or a machine guarding hazard (among other alternatives). In this case, the reward module 110 may determine the first reward 204 based at least in part on a hazard response type associated with the first hazard response operation (e.g., by querying the reward database 114 based on the hazard response type).

FIG. 2 further illustrates that the response module 108 may be configured to receive second information 212 (identified as “Participant(2) Information” in FIG. 2) from the second computing device 142 associated with the second participant 132. The response module 108 may be configured to determine, based on the second information 212, whether second response criteria associated with performing the second response operation (e.g., retrieving the safety equipment device 184 from the fifth location 186 and/or delivering the safety equipment device 184 to the third location 124) is satisfied. In the example of FIGS. 1 and 2, the second participant 132 is assigned the task of locating the safety equipment device 184. While FIGS. 1 and 2 illustrate an example in which the safety equipment device 184 includes an AED device, in other cases, the safety equipment device 184 may include a fire extinguisher, a chemical responder safety device, a biological responder safety device, or a first aid kit (among other alternatives).

When the second response criteria is satisfied, the reward module 110 may be configured to determine a second reward 214 to be provided to the second participant 134. FIG. 2 illustrates that, in some cases, information associated with the second reward 214 may be sent to the second computing device 142 (e.g., for display to the second participant 132).

In some cases, the second information 212 may include second location information associated with the second computing device 142. In other cases, as illustrated and further described herein with respect to FIGS. 3-5, the response module 108 may receive an indication that the second participant 130 is capable of (or incapable of) performing the second response operation. In this case, the response module 108 may determine, based on the indication received from the second participant 132, whether the second response criteria is satisfied.

When the second information 212 includes second location information, the response module 108 may be configured to determine, based on the second location information, whether the second response criteria is satisfied. In a particular embodiment, the second location information may include a second set of GPS coordinates (or location positioning system information) associated with the second computing device 142. The response module 108 may be configured to compare the second location information to location information associated with the location where the response scenario is to be simulated (e.g., the third location 124).

FIG. 2 further illustrates that the response module 108 may be configured to receive safety equipment information 216 associated with the safety equipment device 184. For example, a transmitter (not shown) may be coupled to the safety equipment device 184 in order to allow for location tracking of the safety equipment device 184. In some cases, the response module 108 may be configured to determine, based on the safety equipment information 216, whether the second response criteria is satisfied. To illustrate, the safety equipment database 118 may identify the safety equipment device 184 as being located at the fifth location 186 (see FIG. 1). In a particular embodiment, the safety equipment database 118 may store sets of GPS coordinates (or other location positioning system information) associated with safety equipment devices that are located at various locations. To illustrate, the response module 108 may query the safety equipment database 118 to determine information associated with the fifth location 186 (e.g., a device retrieval location). The response module 108 may determine whether the safety equipment device 118 was successfully retrieved from the fifth location 186 and delivered to the third location 124. As another example, the second participant 132 may scan a tag (e.g., a barcode) on the safety equipment device 184 and scan a tag (e.g., a barcode) displayed via the third computing device 144. Further, the response module 108 may determine whether the second participant 132 returned the safety equipment device 184 to the fifth location 186 (see FIG. 1) after completing the simulated response scenario (so the safety equipment device 184 is available in the event of an actual emergency).

In the particular embodiment illustrated in FIGS. 1 and 2, the response scenario corresponds to an emergency response scenario (e.g., a medical emergency). In this case, the reward module 110 may determine the second reward 214 based at least in part on an emergency response type associated with the second emergency response operation (e.g., by querying the reward database 114 based on the emergency response type).

In a particular embodiment, the first reward 204 may be different from the second reward 214. To illustrate, in some cases, the scenario database 116 may store information associated with difficulty levels of particular response operations. In some cases, the first difficulty level may be different from the second difficulty level. As an example, a first difficulty level may be associated with performing the first response operation (e.g., responding within a particular period of time, simulating CPR, etc.). As another example, a second difficulty level may be associated with performing the second response operation (e.g., responding within a particular period of time, retrieving the safety equipment device 184 from the fifth location 186, delivering the safety equipment device 184 to the third location 124, etc.).

In some cases, the scenario database 116 may store data associated with performing particular response operations (e.g., responder training data, certification data, etc.). As an example, a first set of responder capabilities (e.g., CPR training) may be associated with performing the first response operation. As another example, a second set of responder capabilities may be associated with performing the second response operation (e.g., retrieving the safety equipment device 184, delivering the safety equipment device 184, or a combination thereof).

In the particular embodiment illustrated in FIG. 2, as the third participant 134 is assigned the task of simulating a patient, the third computing device 144 may not send information to the server 102. In other cases, the third participant 134 may utilize the third computing device 144 to send information to the server 102 indicative of whether the first participant 130 was capable of performing CPR (among other possible information). FIG. 2 illustrates that, while the third participant 134 is tasked with simulating a patient, a third reward 224 may be provided to the third participant 134. In a particular embodiment, the third reward 224 may be different from the first reward 204 and/or the second reward 214.

FIG. 2 further illustrates that the response module 108 may be configured to receive fourth information 232 (identified as “Participant(4) Information” in FIG. 2) from the fourth computing device 146 associated with the fourth participant 136. The response module 108 may be configured to determine, based on the fourth information 232, whether response criteria associated with the particular response operation assigned to the fourth participant 146 (e.g., locating the telephone at the sixth location 188 and/or dialing one or more emergency numbers) is satisfied.

In some cases, the fourth information 232 may include fourth location information. In this case, the response module 108 may be configured to determine, based on the fourth location information, whether response criteria associated the particular response operation assigned to the fourth participant 146 is satisfied. In a particular embodiment, the fourth location information may include a set of GPS coordinates (or other location positioning system information) associated with the fourth computing device 146. The response module 108 may be configured to compare the fourth location information to location information associated with the sixth location 188 (e.g., a location of an emergency telephone).

In some cases, the safety equipment database 118 may identify the emergency telephone as being located at the sixth location 188. The response module 108 may query the safety equipment database 118 to determine information associated with the sixth location 188. The response module 108 may determine whether the fourth participant 136 successfully located the emergency telephone based on a comparison of the fourth location information received from the fourth computing device 146 to the sixth location 188. Alternatively or additionally, the response module 108 may be configured to determine whether the fourth participant 136 successfully dialed one or more emergency telephone numbers. To illustrate, an internal emergency telephone number (e.g., extension 222) may not be posted at the sixth location 188, and the response criteria may include the fourth participant 136 being able to successfully remember the internal emergency response extension. As another example, the fourth participant 136 may photograph the telephone (or scan an associated barcode), and a keypad displayed at the fourth computing device 146 may allow the fourth participant 136 to simulate dialing of an emergency telephone number (without actually calling 911, the internal emergency extension, etc.). The server 102 may verify that the fourth participant 136 successfully located the telephone at the sixth location 188 based on the photograph (or scanned barcode). The server 102 may verify that the fourth participant 136 successfully entered the correct emergency telephone number(s) via the keypad displayed at the fourth computing device 146.

In the particular embodiment illustrated in FIGS. 1 and 2, the response scenario corresponds to an emergency response scenario (e.g., a medical emergency). In this case, the reward module 110 may determine the fourth reward 234 based at least in part on an emergency response type associated with the emergency response operation to be performed by the fourth participant 136 (e.g., by querying the reward database 114 based on the emergency response type).

In a particular embodiment, the fourth reward 234 may be different from at least one of the first reward 204, the second reward 214, or the third reward 224. In some cases, the scenario database 116 may store information associated with difficulty levels of particular response operations. In some cases, a difficulty level associated with locating an emergency telephone (and optionally remembering an internal emergency response number) may be different from difficulty levels associated with the response operation(s) assigned to the first participant 130 and/or the second participant 132. As an illustrative, non-limiting example, the first response operation assigned to the first participant 130 (e.g., performing CPR) may be designated as having a greater difficulty level than the second response operation assigned to the second participant 132 (e.g., retrieving/delivering an AED device). The second response operation may be designated as having a greater difficulty level than the response operation assigned to the fourth participant 136 (e.g., locating emergency telephone and/or dialing one or more emergency telephone numbers).

Thus, FIG. 2 illustrates an example of a system of determining, based on information received from computing devices of response scenario participants, whether response operation(s) performed by the individual participants satisfy particular response criteria. When a particular response operation performed by a participant satisfies response criteria associated with the particular response operation, the participant may be rewarded. Rewarding participants for being capable of performing response operations may further encourage the participants to be engaged in the simulation, to obtain further training/certifications, to improve on previous response times, or a combination thereof (among other alternatives).

FIG. 3 illustrates a particular embodiment of a system 300 for rewarding participant(s) for indicating a capability of performing particular response operation(s) associated with one or more response scenarios (e.g., one or more emergency/hazard response scenarios). While FIGS. 1 and 2 illustrate an example of a simulation of a response scenario to evaluate responder capabilities, FIGS. 3-5 illustrate an example of evaluating responder capabilities based on response(s) to various hypothetical response scenario question(s). FIGS. 3-5 further illustrate that rewards may vary based on a difficulty level of a particular question, a number of previous correct answers, or a combination thereof (among other alternatives).

In the particular embodiment illustrated in FIG. 3, the response module 108 may be configured to send first information 302 (identified as “Participant(1) Query” in FIG. 3) to the first computing device 140 associated with the first participant 130. The response module 108 may be configured to send second information 304 (identified as “Participant(2) Query” in FIG. 3) to the second computing device 142 associated with the second participant 132. The response module 108 may be configured to send third information 306 (identified as “Participant(3) Query” in FIG. 3) to the third computing device 144 associated with the third participant 134. The response module 108 may be configured to send fourth information 308 (identified as “Participant(4) Query” in FIG. 3) to the fourth computing device 146 associated with the fourth participant 136. While FIG. 3 illustrates an example in which the same information is sent to each of the computing devices 140-146, it will be appreciated that different information (e.g., alternative/additional scenario response queries) may be sent to one or more of the computing devices 140-146.

In the particular embodiment illustrated in FIG. 3, the first computing device 140 associated with the first participant 130 is configured to display a first user interface 310 (identified as “GUI(1)” in FIG. 3) responsive to receiving the first information 302. In the illustrative, non-limiting example of FIG. 3, the first user interface 310 includes an indication 312 of a particular response scenario (e.g., a graphical illustration of a biohazard response type) and a first query 314 associated with the particular response scenario (e.g., a Yes/No question). While FIG. 3 shows an illustrative, non-limiting example in which the first query 314 prompts the first participant 130 to indicate whether the first participant 130 is capable of locating a first aid kit, it will be appreciated that alternative/additional information may be displayed at the first computing device 140 in order to evaluate a capability/preparedness of the first participant 130. As another example, the first query 314 may prompt the first participant 130 to identify a proper action (e.g., by text entry, by multiple choice selection, etc.). As a further example, the first graphical user interface 310 may present a map of a facility, and the first participant 130 may identify the seventh location 352 on the map.

The second computing device 142 associated with the second participant 132 is configured to display a second user interface 320 (identified as “GUI(2)” in FIG. 3) responsive to receiving the second information 304. In the illustrative, non-limiting example of FIG. 3, the second user interface 320 includes an indication 322 of a particular response scenario (e.g., a graphical illustration of a biohazard response type) and a first query 324 associated with the particular response scenario (e.g., a Yes/No question). While FIG. 3 shows an illustrative, non-limiting example in which the first query 324 prompts the second participant 132 to indicate whether the second participant 132 is capable of locating a first aid kit, it will be appreciated that alternative/additional information may be displayed at the second computing device 142 in order to evaluate a capability/preparedness of the second participant 132.

The third computing device 144 associated with the third participant 134 is configured to display a third user interface 330 (identified as “GUI(3)” in FIG. 3) responsive to receiving the third information 306. In the illustrative, non-limiting example of FIG. 3, the third user interface 330 includes an indication 332 of a particular response scenario (e.g., a graphical illustration of a biohazard response type) and a first query 334 associated with the particular response scenario (e.g., a Yes/No question). While FIG. 3 shows an illustrative, non-limiting example in which the first query 334 prompts the third participant 134 to indicate whether the third participant 134 is capable of locating a first aid kit, it will be appreciated that alternative/additional information may be displayed at the third computing device 144 in order to evaluate a capability/preparedness of the third participant 134.

The fourth computing device 146 associated with the fourth participant 136 is configured to display a fourth user interface 340 (identified as “GUI(4)” in FIG. 1) responsive to receiving the fourth information 308. In the illustrative, non-limiting example of FIG. 3, the fourth user interface 340 includes an indication 342 of a particular response scenario (e.g., a graphical illustration of a biohazard response type) and a first query 344 associated with the particular response scenario (e.g., a Yes/No question). While FIG. 3 shows an illustrative, non-limiting example in which the first query 344 prompts the fourth participant 136 to indicate whether the fourth participant 136 is capable of locating a first aid kit, it will be appreciated that alternative/additional information may be displayed at the fourth computing device 146 in order to evaluate a capability/preparedness of the fourth participant 136.

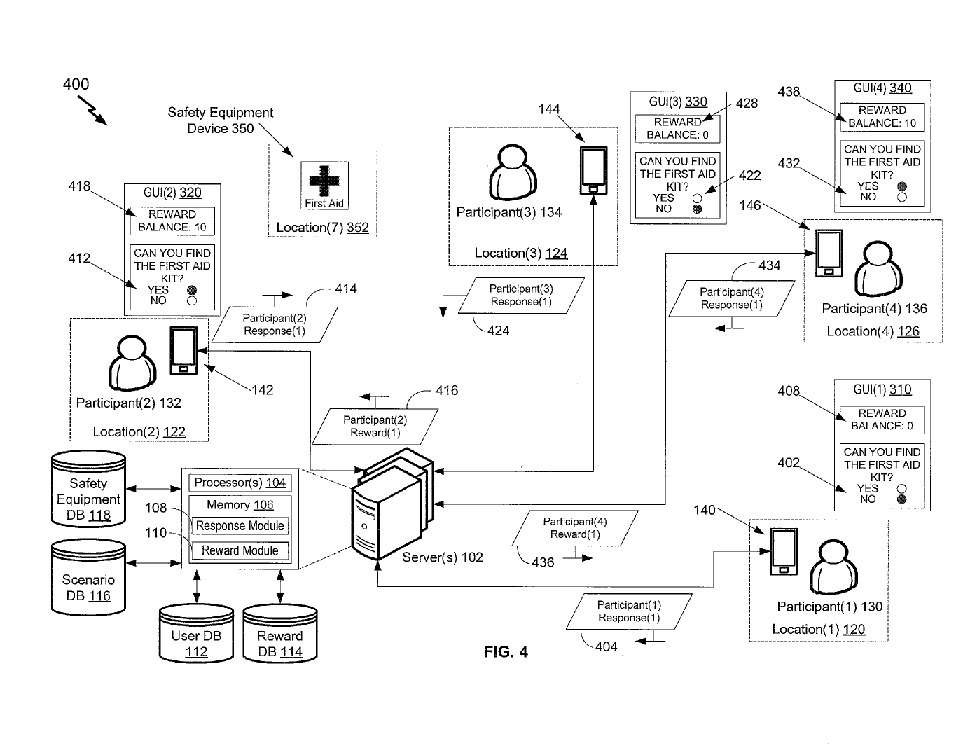

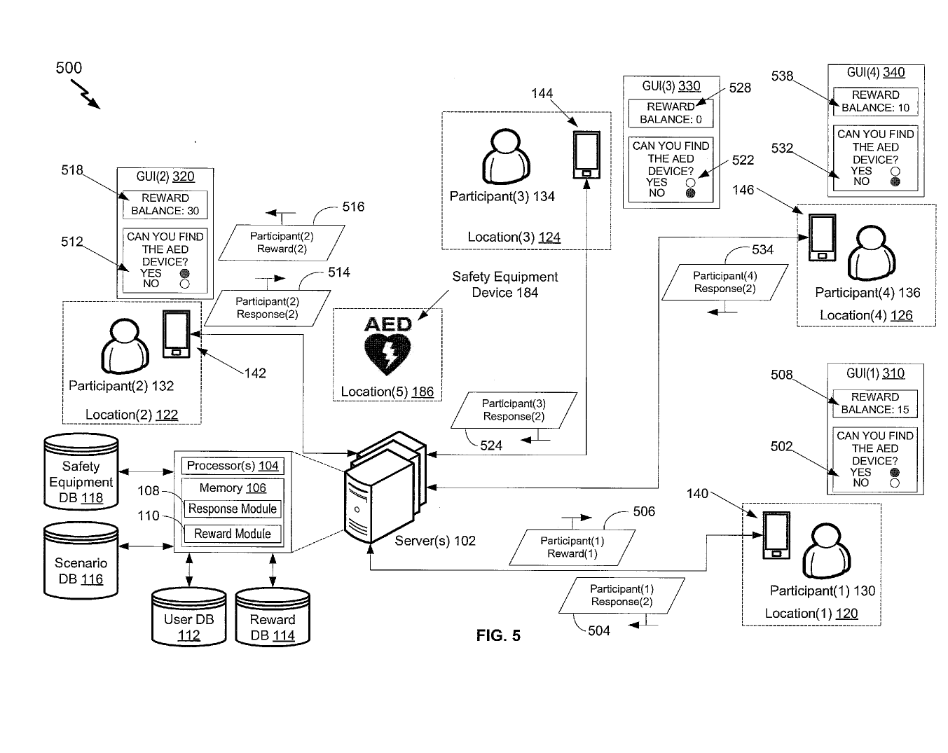

As described further herein with respect to FIGS. 4 and 5, when a particular response provided by a participant satisfies response criteria, the reward module 110 may determine that the participant is to receive a reward. To illustrate, the response criteria may include providing a correct answer to a Yes/No question, identifying a proper action, or demonstrating an ability (e.g., identifying a location on a map), among other alternatives. As further described herein, the reward may be determined based on a nature/type of the particular response scenario, a number of questions previously answered correctly by the participant, an amount of time for the participant to provide a response, or a combination thereof (among other alternatives). In other cases (e.g., when the response criteria is not satisfied), the reward module 110 may determine that the participant is to receive no reward (or a reduced reward, a reward balance deduction, etc.). As an example, the reward module 110 may determine that the participant is to receive a reduced reward for being able to locate the safety equipment device but not being able to deliver the safety equipment device within a threshold period of time. As a further example, the reward module 110 may determine that the participant's reward balance is to be reduced when the participant is unable to locate the safety equipment device.

In the particular embodiment illustrated in FIG. 3, a safety equipment device 350 (e.g., a first aid kit) is located at a seventh location 352. While not shown in the example of FIG. 3, in some cases, the graphical user interfaces 310, 320, 330, and 340 may allow the participants 130-136 to provide information identifying the seventh location 352. Further, in some cases, the scenario response criteria may include actually locating the safety equipment device 350 at the seventh location 352. In some cases, the response module 108 may determine whether a participant successfully located the safety equipment device 350 based on a comparison of location information associated with a particular computing device to the seventh location 352.

Thus, FIG. 3 illustrates an example of a system of evaluating responder capabilities based on response(s) to various hypothetical response scenario question(s). As described further herein with respect to FIGS. 4 and 5, rewards that are provided to scenario participants may vary based on a difficulty level of a particular question, a number of previous correct answers, or a combination thereof (among other alternatives).

FIG. 4 illustrates a particular embodiment of a system 400 of rewarding a participant in the simulated response scenario for satisfying first response criteria associated with a first response operation. In FIG. 4, a participant response (e.g., an answer to a Yes/No question) may be used to determine whether to provide a reward to a particular participant. In other examples, the participant response may include identifying a proper action or demonstrating an ability (e.g., identifying a location on a map), among other alternatives. FIG. 4 further illustrates that a reward that is provided to a particular scenario participant may vary based on a difficulty level of a particular question, a number of previous correct answers, a time to respond to a particular question, or a combination thereof.

In the particular embodiment illustrated in FIG. 4, the response module 108 may be configured to receive, from the first computing device 140, an indication 402 that the first participant 130 is not capable of performing the first response operation. The indication 402 may be sent from the first computing device 140 to the server 102 (e.g., via one or more networks, not shown in FIG. 4) as first response information 404 (identified as “Participant(1) Response(1)” in FIG. 4). The reward module 110 may be configured to determine, based on the indication 402 (included in the first response information 404), whether the first response criteria is satisfied. In the example of FIG. 4, the indication 402 from the first participant 130 includes a “No” answer regarding whether the first participant 130 is capable of locating a first aid kit (e.g., the safety equipment device 350 at the seventh location 352). The first graphical user interface 310 indicates that a reward balance of the first participant 130 is zero, as shown at 408.

In the particular embodiment illustrated in FIG. 4, the response module 108 may be configured to receive, from the second computing device 142, an indication 412 that the second participant 130 is capable of performing the first response operation. The indication 412 may be sent from the second computing device 142 to the server 102 (e.g., via one or more networks, not shown in FIG. 4) as first response information 414 (identified as “Participant(2) Response(1)” in FIG. 4). The reward module 110 may be configured to determine, based on the indication 412 (included in the first response information 414), whether the first response criteria is satisfied. In the example of FIG. 4, the indication 412 from the second participant 132 includes a “Yes” answer regarding whether the second participant 132 is capable of locating a first aid kit (e.g., the safety equipment device 350 at the seventh location 352). In this case, the reward module 110 may determine a reward to be provided to the second participant 132 and provide information 416 associated with the reward (identified as “Participant(2) Reward(1)” in FIG. 4) to the second computing device 142. Based on the information 416 associated with the reward, a reward balance of the second participant 130 may be updated and displayed via the second user interface 320, as shown at 418.

In the particular embodiment illustrated in FIG. 4, the response module 108 may be configured to receive, from the third computing device 144, an indication 422 that the third participant 134 is not capable of performing the first response operation. The indication 422 may be sent from the second computing device 144 to the server 102 (e.g., via one or more networks, not shown in FIG. 4) as first response information 424 (identified as “Participant(3) Response(1)” in FIG. 4). The reward module 110 may be configured to determine, based on the indication 422 (included in the first response information 424), whether the first response criteria is satisfied. In the example of FIG. 4, the indication 422 from the third participant 134 includes a “No” answer regarding whether the third participant 134 is capable of locating a first aid kit (e.g., the safety equipment device 350 at the seventh location 352). The third graphical user interface 330 indicates that a reward balance of the third participant 134 is zero, as shown at 428.

In the particular embodiment illustrated in FIG. 4, the response module 108 may be configured to receive, from the fourth computing device 144, an indication 432 that the fourth participant 136 is capable of performing the first response operation. The indication 432 may be sent from the fourth computing device 146 to the server 102 (e.g., via one or more networks, not shown in FIG. 4) as first response information 434 (identified as “Participant(4) Response(1)” in FIG. 4). The reward module 110 may be configured to determine, based on the indication 432 (included in the first response information 434), whether the first response criteria is satisfied. In the example of FIG. 4, the indication 432 from the fourth participant 136 includes a “Yes” answer regarding whether the fourth participant 136 is capable of locating a first aid kit (e.g., the safety equipment device 350 at the seventh location 352). In this case, the reward module 110 may determine a reward to be provided to the fourth participant 136 and provide information 436 associated with the reward (identified as “Participant(4) Reward(1)” in FIG. 4) to the fourth computing device 146. Based on the information 436 associated with the reward, a reward balance of the fourth participant 136 may be updated and displayed via the fourth user interface 340, as shown at 438.

Thus, FIG. 4 illustrates an example of a system of rewarding a participant in a simulated response scenario for satisfying first response criteria associated with a first response operation. In FIG. 4, a participant response (e.g., an answer to a Yes/No question) may be used to determine whether to provide a reward to a particular participant.

FIG. 5 illustrates a particular embodiment of a system 500 of rewarding a participant in the simulated response scenario for satisfying second response criteria associated with a second response operation. In FIG. 5, a participant response (e.g., an answer to a Yes/No question) may be used to determine whether to provide a reward to a particular participant. In other examples, the participant response may include identifying a proper action or demonstrating an ability (e.g., identifying a location on a map), among other alternatives. FIG. 5 further illustrates that a reward that is provided to a particular scenario participant may vary based on a difficulty level of a particular question, a number of previous correct answers, a time to respond to the particular question, or a combination thereof.

In the particular embodiment illustrated in FIG. 5, the response module 108 may be configured to receive, from the first computing device 140, an indication 502 that the first participant 130 is capable of performing the second response operation. The indication 502 may be sent from the first computing device 140 to the server 102 (e.g., via one or more networks, not shown in FIG. 5) as second response information 504 (identified as “Participant(1) Response(2)” in FIG. 5). The reward module 110 may be configured to determine, based on the indication 502 (included in the second response information 504), whether the second response criteria is satisfied. In the example of FIG. 5, the indication 502 from the first participant 130 includes a “Yes” answer regarding whether the first participant 130 is capable of locating an AED device (e.g., the safety equipment device 184 at the fifth location 186). In this case, the reward module 110 may determine a reward to be provided to the first participant 130 and provide information 506 associated with the reward (identified as “Participant(1) Reward(1)” in FIG. 5) to the first computing device 140. Based on the information 506 associated with the reward, a reward balance of the first participant 130 may be updated and displayed via the first user interface 310, as shown at 508.

In the particular embodiment illustrated in FIG. 5, the response module 108 may be configured to receive, from the second computing device 142, an indication 512 that the second participant 130 is capable of performing the second response operation. The indication 512 may be sent from the second computing device 142 to the server 102 (e.g., via one or more networks, not shown in FIG. 5) as second response information 514 (identified as “Participant(2) Response(2)” in FIG. 5). The reward module 110 may be configured to determine, based on the indication 512 (included in the second response information 514), whether the second response criteria is satisfied. In the example of FIG. 5, the indication 512 from the second participant 132 includes a “Yes” answer regarding whether the second participant 132 is capable of locating an AED device (e.g., the safety equipment device 184 at the fifth location 186). In this case, the reward module 110 may determine a reward to be provided to the second participant 132 and provide information 516 associated with the reward (identified as “Participant(2) Reward(2)” in FIG. 5) to the second computing device 142. Based on the information 516 associated with the reward, a reward balance of the second participant 132 may be updated and displayed via the second user interface 320, as shown at 518.

In the example of FIG. 5, the reward balance associated with the second participant 132 is increased from ten (see FIG. 4) to thirty (as shown at 518), representing a reward of twenty reward points. The reward balance of the first participant 130 is increased from zero (see FIG. 4) to fifteen (as shown at 508), representing a reward of fifteen reward points. Thus, FIG. 5 illustrates that a number of previous responses from a participant that are indicative of particular response capabilities may be used by the reward module 110 when determining a particular reward to be provided. FIG. 5 further illustrates that a difficulty level of a particular response operation may be used by the reward module 110 when determining a particular reward to be provided. To illustrate, the reward 434 provided to the fourth participant 136 in FIG. 4 (e.g., ten reward points) for being capable of locating the first aid kit is different from the reward 506 provided to the first participant 130 in FIG. 5 (e.g., fifteen reward points) for being capable of locating the AED device.

In the particular embodiment illustrated in FIG. 5, the response module 108 may be configured to receive, from the third computing device 144, an indication 522 that the third participant 134 is not capable of performing the second response operation. The indication 522 may be sent from the second computing device 144 to the server 102 (e.g., via one or more networks, not shown in FIG. 5) as second response information 524 (identified as “Participant(3) Response(2)” in FIG. 5). The reward module 110 may be configured to determine, based on the indication 522 (included in the second response information 524), whether the second response criteria is satisfied. In the example of FIG. 5, the indication 522 from the third participant 134 includes a “No” answer regarding whether the third participant 134 is capable of locating an AED device (e.g., the safety equipment device 350 at the seventh location 352). The third graphical user interface 330 indicates that a reward balance of the third participant 134 remains zero, as shown at 528.

In the particular embodiment illustrated in FIG. 5, the response module 108 may be configured to receive, from the fourth computing device 146, an indication 532 that the fourth participant 136 is not capable of performing the second response operation. The indication 532 may be sent from the fourth computing device 146 to the server 102 (e.g., via one or more networks, not shown in FIG. 5) as second response information 534 (identified as “Participant(4) Response(2)” in FIG. 5). The reward module 110 may be configured to determine, based on the indication 532 (included in the second response information 534), whether the second response criteria is satisfied. In the example of FIG. 5, the indication 532 from the fourth participant 136 includes a “No” answer regarding whether the fourth participant 136 is capable of locating an AED device (e.g., the safety equipment device 350 at the seventh location 352). The fourth graphical user interface 340 indicates that a reward balance of the fourth participant 136 remains ten, as shown at 538.

Thus, FIG. 5 illustrates an example of a system of rewarding a participant in a simulated response scenario for satisfying second response criteria associated with a second response operation. In FIG. 5, a participant response (e.g., an answer to a Yes/No question) may be used to determine whether to provide a reward to a particular participant.

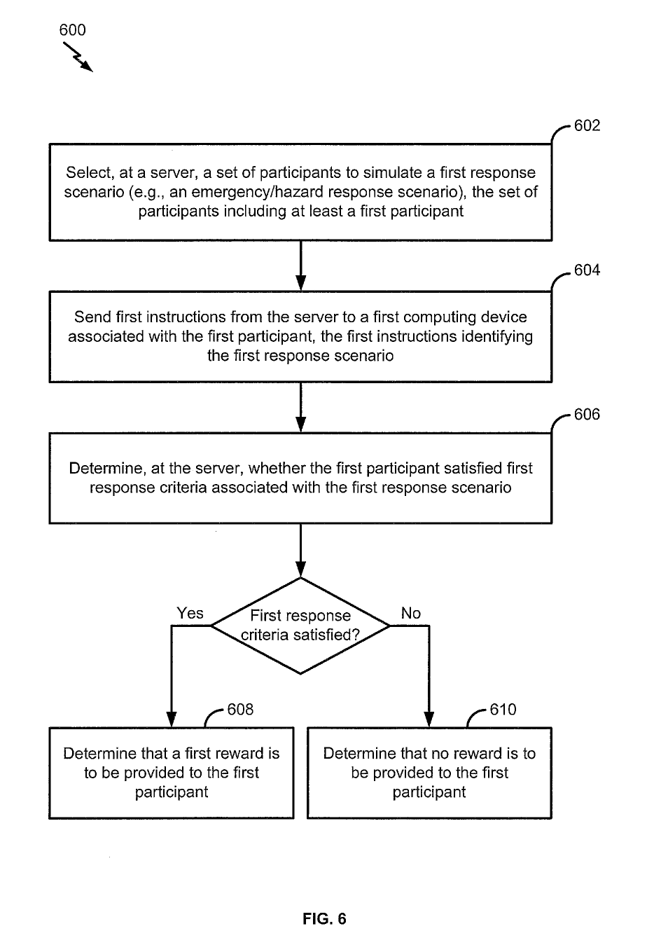

FIG. 6 illustrates a particular embodiment of a method 600 of determining whether to reward a participant in a simulated response scenario based on whether the participant satisfied particular response criteria. In FIG. 6, a server selects a set of participants to simulate a particular response scenario (e.g., an emergency/hazard response scenario). While the method 600 of FIG. 6 illustrates a determination of whether to reward a single participant of the set of participants, it will be appreciated that the method 600 may be performed for other participant(s) of the set of participants.

The method 600 includes selecting, at a server, a set of participants to simulate a first response scenario, at 602. The set of participants includes at least a first participant. As an example, referring to FIGS. 1 and 2, the server 102 may select the first participant 130, the second participant 132, the third participant 134, and the fourth participant 136 to simulate an emergency response scenario (e.g., a heart attack).

The method 600 includes sending first instructions from the server to a first computing device associated with the first participant, at 604. The first instructions identify the first response scenario and/or the first response operation. As an example, referring to FIG. 1, the server 102 may send the first instructions 150 to the first computing device 140 associated with the first participant 130. In FIG. 1, the first instructions 150 indicate that the particular response operation(s) to be performed by the first participant 130 includes performing CPR. As another example, referring to FIG. 1, the server 102 may send the second instructions 152 to the second computing device 142 associated with the second participant 132. In FIG. 1, the second instructions 152 indicate that the particular response operation(s) to be performed by the second participant 132 includes retrieving/delivering an AED device. As a further example, referring to FIG. 1, the server 102 may send the fourth instructions 156 to the fourth computing device 146 associated with the fourth participant 136. In FIG. 1, the fourth instructions 156 indicate that the particular response operation(s) to be performed by the fourth participant 136 includes locating an emergency telephone, dialing one or more emergency telephone numbers, or a combination thereof.

The method 600 includes determining, at the server, whether the first participant satisfied first response criteria associated with the first response scenario, at 606. For example, referring to FIG. 2, the response module 108 of the server 102 may determine whether the first participant 130 satisfied response criteria associated with performing response operation(s) that include simulating CPR on the third participant 134 (designated as the patient). As another example, referring to FIG. 2, the response module 108 may determine whether the second participant 132 satisfied response criteria associated with performing response operation(s) that include retrieving the safety equipment device 184 (e.g., an AED device) from the fifth location 186, delivering the safety equipment device 184 to the third location 124, or a combination thereof. As a further example, referring to FIG. 2, the response module 108 may determine whether the fourth participant 136 satisfied response criteria associated with performing response operation(s) that include locating the emergency telephone at the sixth location 188, dialing one or more emergency telephone numbers (e.g., 911, an internal emergency number, etc.), or a combination thereof.

In response to determining that the first response criteria are satisfied, the method 600 includes determining that a first reward is to be provided to the first participant, at 608. For example, referring to FIG. 2, the reward module 110 may determine that the first reward 204 is to be provided to the first participant 130 (e.g., for successfully simulating CPR). As another example, referring to FIG. 2, the reward module 110 may determine that the second reward 214 is to be provided to the second participant 132 (e.g., for successfully locating/delivering the safety equipment device 184). As a further example, referring to FIG. 2, the reward module 110 may determine that the fourth reward 234 is to be provided to the fourth participant 136 (e.g., for successfully locating the emergency telephone and/or calling for help).

In the particular embodiment illustrated in FIG. 6, the method 600 includes determining that no reward is to be provided to the first participant when the first response criteria are not satisfied, at 610. While not shown in the example of FIG. 2, it will be appreciated that the reward module 110 may determine that no reward is to be provided to one or more of the participants 130-136. As an illustrative, non-limiting example, while the second participant 132 may have successfully retrieved the safety equipment device 184 (e.g., the AED device) from the fifth location 186, the second participant 132 may not have delivered the safety equipment device 184 to the third location 124 within a threshold amount of time. To illustrate, to be considered a successful AED retrieval/delivery operation, the scenario database 116 may store data that specifies that the AED device is to be delivered no later than three minutes after a start time of a heart attack emergency scenario simulation.

Thus, FIG. 6 illustrates an example of a method of rewarding a participant in a simulated response scenario when the participant satisfies particular response criteria (associated with a particular response operation to be performed by the participant). A simulation of a response scenario may result in the participant being more engaged and more likely to be prepared in the event of an actual response scenario. Rewarding the participant for being capable of actually performing a particular response operation (or multiple response operations) may further encourage the participant to be engaged in the simulation. When the participant is not capable of actually performing the particular response operation (or multiple response operations), the lack of a reward may incentivize the participant to improve his/her scenario response skillset (e.g., to obtain CPR certification, to learn the locations of various safety equipment devices/exits, etc.).

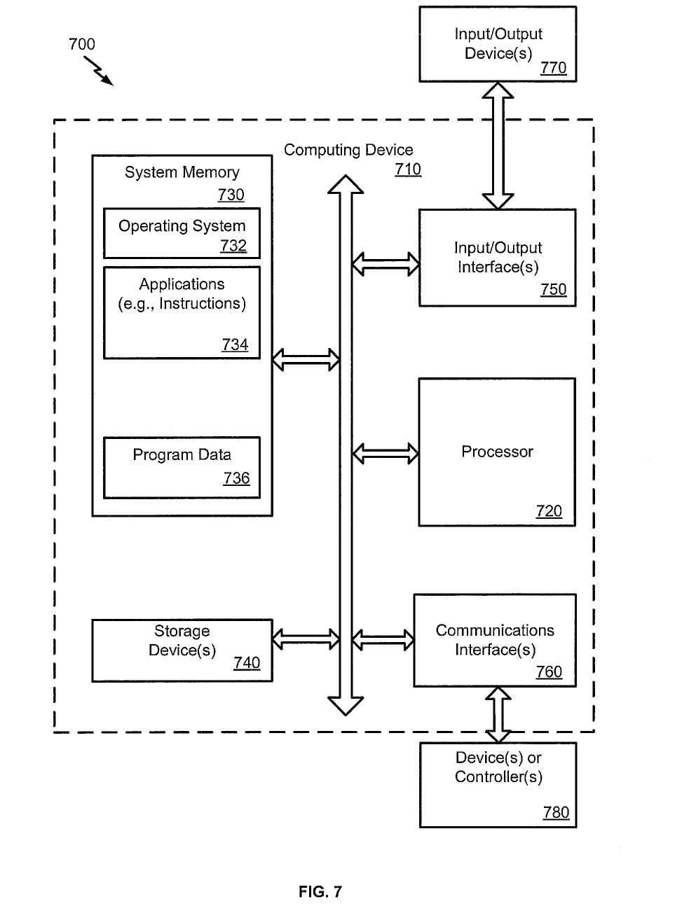

FIG. 7 is an illustration of a block diagram of a computing environment 700 including a general purpose computing device 710 configured to support embodiments of computer-implemented methods and computer-executable program instructions (or code) according to the present disclosure. The computing device 710, or portions thereof, may further execute instructions according to any of the methods described herein. In a particular embodiment, the computing device 710 of FIG. 7 may correspond to the server(s) 102 illustrated in FIGS. 1-5. Alternatively, the computing device 710 of FIG. 7 may correspond to one or more of the computing devices 140-146 illustrated in FIGS. 1-5.

The computing device 710 may include a processor 720. The processor 720 may communicate with the system memory 730, one or more storage devices 740, one or more input/output interfaces 750, one or more communications interfaces 760, or a combination thereof. The system memory 730 may include volatile memory devices (e.g., random access memory (RAM) devices), nonvolatile memory devices (e.g., read-only memory (ROM) devices, programmable read-only memory, and flash memory), or both. The system memory 730 may include an operating system 732, which may include a basic/input output system for booting the computing device 710 as well as a full operating system to enable the computing device 710 to interact with users, other programs, and other devices. The system memory 730 may include one or more applications 734 which may be executable by the processor 720. For example, the one or more applications 734 may include instructions executable by the processor 720 to perform various operations. Further, the system memory 730 may include program data 736 usable for performing various operations described herein.

As an example, the application(s) 734 may include instructions executable by the processor 720 to determine a set of participants to simulate a response scenario, where the set of participants includes at least a first participant. In some cases, the set of participants may further include at least a second participant. The application(s) 734 may also include instructions executable by the processor 720 to send, to a first computing device associated with the first participant, first information that identifies a response scenario. In some cases (e.g., when the set of participants includes at least a second participant), the application(s) 734 may also include instructions executable by the processor 720 to send second instructions to a second computing device associated with a second participant, where the second instructions identify the response scenario. The application(s) 734 may also include instructions executable by the processor 720 to assign particular response operations to particular participants (e.g., a first response operation for a first participant, a second response operation for a second participant, etc.).

The application(s) 734 may also include instructions executable by the processor 720 to determine whether first response criteria associated with the first response operation is satisfied (e.g., based on first information received from the first computing device). The first information may include first location information associated with the first computing device or a first indication that the first participant is capable of (or incapable of) performing the first response operation.

The application(s) 734 may also include instructions executable by the processor 720 to determine a first reward to be provided to the first participant in response to the first participant satisfying the first response criteria. The application(s) 734 may also include instructions executable by the processor 720 to provide the first reward to the first participant (e.g., by storing information associated with the first reward in a reward database). In some cases, the application(s) 734 may include instructions executable by the processor 720 to generate a user interface that includes information associated with the first reward.

In some cases (e.g., when the set of participants includes at least a second participant), the application(s) 734 may also include instructions executable by the processor 720 to determine whether second response criteria is satisfied (e.g., based on second information received from the second computing device). The second information may include second location information associated with the second computing device or a second indication that the second participant is capable of (or incapable of) performing the second response operation.

The application(s) 734 may also include instructions executable by the processor 720 to determine a second reward to be provided to the second participant in response to the second participant satisfying the second response criteria. The application(s) 734 may also include instructions executable by the processor 720 to provide the second reward to the second participant (e.g., by storing information associated with the second reward in a reward database). In some cases, the application(s) 734 may include instructions executable by the processor 720 to generate a user interface that includes information associated with the second reward.

The processor 720 may also communicate with one or more storage devices 740. For example, the one or more storage devices 740 may include nonvolatile storage devices, such as magnetic disks, optical disks, or flash memory devices. The storage devices 740 may include both removable and non-removable memory devices. The storage devices 740 may be configured to store an operating system, images of operating systems, applications, and program data. In a particular embodiment, the memory 730, the storage devices 740, or both, include tangible computer-readable media. In a particular embodiment, the storage devices 740 illustrated in FIG. 7 may correspond to the user database 112 of FIGS. 1-5, the reward database 114 of FIGS. 1-5, the scenario database 116 of FIGS. 1-5, the safety equipment database 118 of FIGS. 1-5, or a combination thereof.

The processor 720 may also communicate with one or more input/output interfaces 750 that enable the computing device 710 to communicate with one or more input/output devices 770 to facilitate user interaction. The processor 720 may detect interaction events based on user input received via the input/output interfaces 750. Additionally, the processor 720 may send a display to a display device via the input/output interfaces 750. The processor 720 may communicate with devices or controllers 780 via the one or more communications interfaces 760.

Embodiments described above are illustrative and do not limit the disclosure. It is to be understood that numerous modifications and variations are possible in accordance with the principles of the present disclosure.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, method steps may be performed in a different order than is shown in the figures or one or more method steps may be omitted. Accordingly, the disclosure and the figures are to be regarded as illustrative rather than restrictive.

Moreover, although specific embodiments have been illustrated and described herein, it is to be appreciated that any subsequent arrangement designed to achieve the same or similar results may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the claimed subject matter may be directed to less than all of the features of any of the disclosed embodiments.

What is claimed is:

1. A method comprising:
selecting, at a server, a set of participants to simulate a first response scenario, the set of participants including at least a first participant;
sending first instructions from the server to a first computing device associated with the first participant, wherein the first instructions identify the first response scenario;
determining, at the server, whether the first participant satisfied first response criteria associated with a first response operation; and
in response to determining that the first participant satisfied the first response criteria, determining a first reward to be provided to the first participant.

2. The method of claim 1, further comprising:
assigning the first response operation to the first participant; and
determining that the first response criteria is satisfied when the first participant is capable of performing the first response operation.

3. The method of claim 2, wherein the first response scenario corresponds to an emergency response scenario, and wherein the first response operation corresponds to a first emergency response operation.

4. The method of claim 2, wherein the first reward is determined based at least in part on an emergency response type associated with the first emergency response operation.

5. The method of claim 1, wherein the first response scenario corresponds to a safety hazard response scenario, and wherein the first response operation corresponds to a first hazard response operation.

6. The method of claim 5, wherein the safety hazard response scenario corresponds to a fire hazard, a chemical spill hazard, a lighting hazard, a tripping hazard, a broken glass hazard, a broken tool hazard, a cross-walk hazard, an iced surface hazard, or a machine guarding hazard.

7. The method of claim 5, wherein the first reward is determined based at least in part on a hazard response type associated with the first hazard response operation.

8. The method of claim 1, further comprising:
sending second instructions from the server to a second computing device associated with a second participant of the set of participants, wherein the second instructions identify a second response operation associated with the first response scenario;
determining, at the server, whether the second participant satisfied second response criteria associated with the second response operation; and
in response to determining that the second participant satisfied the first response criteria, determining a second reward to be provided to the second participant.

9. The method of claim 8, wherein:
the first reward is determined based at least in part on a first response type associated with the first response operation;
the second reward is determined based at least in part on a second response type associated with the second response operation; and
the first reward is different from the second reward.

10. The method of claim 9, wherein:
a first difficulty level is associated with performing the first response operation;
a second difficulty level is associated with performing the second response operation; and
the first difficulty level is different from the second difficult level.

11. The method of claim 9, wherein:
a first set of responder capabilities is associated with performing the first response operation;
a second set of responder capabilities is associated with performing the second response operation; and
the first set of responder capabilities is different from the second set of responder capabilities.

12. The method of claim 11, wherein the first set of responder capabilities includes cardiopulmonary resuscitation (CPR) training.

13. The method of claim 1, wherein the first response operation includes locating a safety equipment device, the safety equipment device including a fire extinguisher, an automated external defibrillator (AED) device, a chemical responder safety device, a biological responder safety device, or a first aid kit.

14. The method of claim 1, wherein the set of participants is selected based on a group affiliation, a workplace responsibility, or a combination thereof.

15. A system comprising:
a processor;
a memory accessible to the processor, the memory including instructions executable by the processor to perform operations including:
determining a set of participants to simulate a response scenario, the set of participants including at least a first participant;
sending, to a first computing device associated with the first participant, first information that identifies the first response scenario; and
determining a first reward to be provided to the first participant in response to the first participant satisfying first response criteria associated with a first response operation.

16. The system of claim 15, wherein the operations further include:
receiving, from the first computing device, an indication that the first participant is capable of performing the first response operation; and
determining, based on the indication, that the first response criteria is satisfied.

17. The system of claim 15, wherein the operations further include:
receiving location information from the first computing device; and
determining, based on the location information, that the first response criteria is satisfied.

18. A computer-readable storage medium comprising instructions that are executable by a processor to perform operations including:
determining a set of participants to simulate a response scenario, the set of participants including at least a first participant and a second participant;
sending first instructions to a first computing device associated with the first participant, wherein the first instructions identify the response scenario;
sending second instructions to a second computing device associated with the second participant, wherein the second instructions identify the response scenario;
providing a first reward to the first participant in response to determining that first response criteria associated with a first response operation is satisfied; and
providing a second reward to the second participant in response to determining that second response criteria associated with a second response operation is satisfied.

19. The computer-readable storage medium of claim 18, wherein the operations further include:
determining, based on first information received from the first computing device, that the first response criteria is satisfied; and
determining, based on second information received from the second computing device, that the second response criteria is satisfied.

20. The computer-readable storage medium of claim 19, wherein:
the first information includes first location information associated with the first computing device or a first indication that the first participant is capable of performing the first response operation; and
the second information includes second location information associated with the second computing device or a second indication that the second participant is capable of performing the second response operation.
